(19) United States
(12) Patent Application Publication
(10) Pub. No.: US 2002/0070177 A1
(43) Pub. Date: Jun. 13, 2002

(54) Water treatment assembly

(76) Inventor: Henry Kozlowski, Willowdale (CA)

Correspondence Address: McCormick, Paulding & Huber, City Place II, 185 Asylum Street, Hartford, CT, 06103-3402, US

(21) Appl. No.: 09/977,016

(22) Filed: Oct. 12, 2001

Related U.S. Application Data
(60) Provisional application No. 60/239,839, filed on Oct. 12, 2000.
(60) Provisional application No. 60/301,999, filed on Jun. 29, 2001.

(30) Foreign Application Priority Data
Oct. 12, 2000 (CA) 2,323,299

(51) Int. Cl. C02F 1/48

(52) U.S. Cl. 210/748; 250/436

(57) ABSTRACT

A ballast module, for powering UV lamps in a fluid treatment assembly, that has electronic ballast with a high resonance frequency. The high resonance frequency reduces the size of the components so that the ballast module can be mounted in proximity with the UV lamps where the ballast module is also cooled by the fluid being treated by the UV lamps.

### CROSS-REFERENCE TO RELATED APPLICATIONS

This application is related to and claims priority to U.S. provisional application entitled “WATER TREATMENT ASSEMBLY” having serial No. 60/239,839, by Henry Kozlowski, filed Oct. 12, 2000 and incorporated by reference herein. This application is related to and claims priority to Canadian application entitled “WATER TREATMENT ASSEMBLY” having serial number 2,323,299, by Henry Kozlowski, filed Oct. 12, 2000 and incorporated by reference herein. This application is related to and claims priority to U.S. provisional application entitled “DISCHARGE LAMPS” having serial No. 60/301,999, by Henry Kozlowski, filed Jun. 29, 2001 and incorporated by reference herein.

### FIELD OF THE INVENTION

The present invention relates to assemblies for the purification or disinfection of fluid, especially water, using ultraviolet light, and particularly to operating a ballast in excess of 50 kHz in such assemblies.

### BACKGROUND TO THE INVENTION

It is well known to treat water, particularly wastewater, with ultraviolet light in order to effect a purification or disinfection of the water so that it is suitable for discharge into a lake, river or stream or so that the water is potable water and suitable for consumption.

Ultraviolet treatment systems use lamps with ballast modules to produce the ultraviolet (UV) light. The ultraviolet systems for wastewater typically have a plurality of elongated ultraviolet lamps arranged in a parallel space-apart relationship and they are supported in a frame. Racks of ultraviolet lamps in a frame are typically placed in a channel through which the water is passed. The lamps are located underwater. The lamps are enclosed in a sheath typically formed of quartz. A ballast module will typically operate more than one lamp. Depending upon the flow rate, the number of ballast modules in an ultraviolet treatment system may vary from one to tens of thousands.

The Ballast modules produce heat during use, regardless of whether they have an electronic or older core-coil style ballast. Thus, the cooling of the ballast is important to the operation of the system, as the higher the operating temperature of the ballast, the shorter the lifetime of the ballast. The dissipation of heat from the ballast is a major consideration when ultraviolet treatment systems are used for the disinfection of water and wastewater.

A variety of methods may be used to dissipate the heat. For example, the heat from the ballast may be dissipated using fans, or an air conditioner may be attached to the system. In some instances, the ultraviolet treatment systems may be placed in air-conditioned buildings. Cooling lines may be passed through containers holding the ballast. Air conditioners and cooling systems are costly to operate.

Alternatively, the ballast may be placed on top of the frame containing the ultraviolet lamps, to spread out the positioning of the ballast modules and to facilitate dissipation of heat. However, in hot climates and areas with a lot of sunlight, ballast modules that are placed on the top of the ultraviolet lamp frames may overheat, and buildings with air conditioners or sun shields may be required. Filters on fans or air conditioners used in the cooling of ballast modules are very susceptible to the accumulation of insects and dust, which tend to plug the filters and restrict the flow of air through the filters. Consequently, the ballast modules tend to overheat. To prevent overheating, costly monitoring systems, maintenance and backup ultraviolet treatment systems are required.

Wastewater treatment plants are usually built in low-lying areas, to reduce the cost of pumping of sewage to higher elevations. The treated wastewater is often emptied into a body of water e.g. a lake or river. Thus, in some instances, the ultraviolet treatment plant may be on a flood plain, and subjected to periodic flooding as a result of the location of the plant. It may, therefore, be necessary to seek to waterproof the ultraviolet treatment system and cool the ballasts at the same time, which can lead to complex ultraviolet treatment systems.

Due to the variation between the sites and the possibly large number of lamps being deployed, the UV treatment systems can become very complex and consequently difficult to design, construct, and maintain. It is therefore advantageous to modularize the components of UV treatment systems for application to different sites and designs and to simplify the wiring of such systems.

The ability of an ultraviolet light treatment system to inactivate micro-organisms is a function of the UV fluence generated in the treatment system. The UV fluence is the product of the fluence rate and the time. The ability of ultraviolet light to penetrate wastewater, and hence treat the wastewater, is affected by the UV transmission. As the ultraviolet light emitted by the lamp decreases, the fluence rate also decreases. Thus, for a particular ultraviolet lamp, the important factors in the production of ultraviolet light include the age of the lamp, the degree of fouling of the lamps i.e. the degree of fouling of the quartz sleeve on the lamp, and the clarity of the wastewater that is being treated.

Steps may be taken to clean the lamps and especially the quartz sleeve on the lamp. These steps are typically carried out on a periodic basis using scrapers or other techniques.

The clarity of the water to be treated may be difficult or impossible to control. It is therefore advantageous to be able to control the power setting of the lamps to generate the level of UV required to inactivate the micro-organisms.

In addition, the amount of ultraviolet light obtainable from an ultraviolet lamp is limited. Thus, the consequence of the need to provide an UV fluence to efficiently and effectively treat the water is that there is a tendency and desire to place the ultraviolet lamps closer and closer together and/or to use more ultraviolet lamps. This tends to result in a headloss of water flowing through the treatment system. The cross-section of the ultraviolet lamps and their protective sleeves must be minimized in order to reduce the headloss. Structural components of the rack of ultraviolet lamps are also a factor. If the ballast modules are placed under water in-line and next to the ultraviolet lamps on the rack, as is known, the ballast becomes a major limiting factor in the placement of the lamps closer together. It is therefore advantageous to reduce the size of the ballast as much as possible to reduce the headloss.

It is therefore an object of an aspect of the present invention for providing a UV treatment assembly having ease of adaptation to different water treatment sites, ease of construction and manufacture, and ease of maintenance.

### SUMMARY OF THE INVENTION

According to an aspect of the present invention, there is provided a ballast module, for powering UV lamps in a fluid treatment assembly, that has an electronic ballast with a high resonance frequency. The high resonance frequency reduces the size of the components so that the ballast module can mounted in proximity with the UV lamps where the ballast module is also cooled by the fluid being treated by the UV lamps.

According to an aspect of the present invention, there is provided a ballast module. Each ballast module has all of the necessary components to control and to convert power line electrical energy into a form acceptable by at least one UV lamp, and to communicate with an assembly control unit to receive commands and to provide status information on the ballast module and UV lamps. The ballast modules are standardized for use in a number of UV water treatment assemblies of varying configurations.

For a particular water treatment site, a standardized ballast module may be used in all of the water treatment assemblies thereby simplifying manufacture and maintenance since there is only one part, versus a number of parts, to manufacture and to store in the spares inventory.

In one embodiment, where the ballast modules in the UV rack communicate over a single twisted-pair cable and receive power from a single power line from a control cabinet, construction of the water treatment assemblies are simplified as individual cables do not have to be laid from each ballast module in a control cabinet to the UV lamps in the racks. In another embodiment, where the ballast modules have the capability to communicate over electrical power lines; the frames of the water treatment assemblies may have one common set of electrical conductors to all of the ballast modules for both communication and power purposes thereby further simplifying construction and maintenance.

In another embodiment, the ballast modules have electronic ballasts operating resonant circuits at frequencies in excess of 50 kHz, instead of the common 35 kHz, to drive the UV lamps. The advantages of operating at these frequencies include reducing the size of the inductor or transformer elements of a ballast sufficiently to allow ballast modules to be mounted in-line with standard elongate UV lamps with minimal headloss of water flow. Other advantages include capacitive isolation and improved power level adjustment for the UV lamps. Capacitors, instead of large transformers, are used to isolate the power lines from the power outlets to the UV lamps. The power level of the UV lamps is adjusted by varying the frequency of the resonant circuits: the further the frequency of the resonant circuits are operated away from resonance, the lower the amount of power is transferred to the UV lamps.

According to another aspect of the present invention, there is provided a fluid treatment assembly, comprising: a plurality of ultraviolet lamps adapted to be immersed in a fluid when the assembly is in use; a plurality of ballast modules for powering said ultraviolet lamps, each of said ballast modules having a ballast electrically connected to at least one ultraviolet lamp for powering said at least one ultraviolet lamp, the ballast having a resonant circuit with a resonance frequency for generating an alternating voltage source to power said at least one ultraviolet lamp and a driver circuit with a pulse frequency for supplying the resonant circuit with pulses of electrical energy; a frame member having a portion adapted to be immersed in the fluid when the assembly is in use, the frame member supporting said ultraviolet lamps and said ballast modules; and an electrical system for receiving electrical energy, which has a voltage and a current, and providing such to said ballast modules; wherein the resonance frequency is set in excess of 50 kHz.

According to another aspect of the present invention, there is provided a ballast for powering at least one ultraviolet lamp with electrical energy, said at least one ultraviolet lamp being for use in a photochemical treatment of a fluid, where the ballast is to be immersed in the fluid for cooling by the fluid, the ballast comprising: a resonant circuit having a resonance frequency for generating an alternating voltage source to power said at least one ultraviolet lamp; and a driver circuit having a pulse frequency for supplying the resonant circuit with pulses of electrical energy; wherein the resonance frequency is set in excess of 50 kHz.

According to another aspect of the present invention, there is provided a ballast module for use in a fluid treatment assembly having a frame to support at least one ultraviolet lamp under the control of an assembly control unit, the ballast module comprising: a ballast for converting electrical energy to a form suitable to power at least one ultraviolet lamp; and a control section for interfacing with the assembly control unit and controlling said ballast under direction of the assembly control unit.

According to another aspect of the present invention, there is provided a method of photochemically treating a fluid using a fluid treatment assembly, comprising immersing a plurality of ultraviolet lamps in the fluid when the assembly is in use; powering said ultraviolet lamps using a plurality of ballast modules, each of said ballast modules having a ballast electrically connected to at least one ultraviolet lamp for powering said at least one ultraviolet lamp, the ballast having a resonant circuit with a resonance frequency for generating an alternating voltage source to power said at least one ultraviolet lamp and a driver circuit with a pulse frequency for supplying the resonant circuit with pulses of electrical energy; supporting said ultraviolet lamps and said ballast modules in a frame member having a portion adapted to be immersed in the fluid when the assembly is in use; and receiving electrical energy, which has a voltage and a current, and providing such to said ballast modules; wherein the resonance frequency is set in excess of 50 kHz.

According to another aspect of the present invention, there is provided a method of operating a ballast for powering at least one ultraviolet lamp with electrical energy, said at least one ultraviolet lamp being for use in a photochemical treatment of a fluid, where the ballast is to be immersed in the fluid for cooling by the fluid, the method comprising: generating an alternating voltage source to power said at least one ultraviolet lamp using a resonant circuit having a resonance frequency; and supplying the resonant circuit with pulses of electrical energy using a driver circuit having a pulse frequency; wherein the resonance frequency is set in excess of 50 kHz.

According to another aspect of the present invention, there is provided a fluid treatment assembly, comprising: a ultraviolet lamp adapted to be immersed in a fluid when the assembly is in use; a ballast module for powering said ultraviolet lamp, said ballast module having a ballast electrically connected to said ultraviolet lamp for powering said ultraviolet lamp, the ballast having a resonant circuit with a resonance frequency for generating an alternating voltage source to power said ultraviolet lamp and a driver circuit with a pulse frequency for supplying the resonant circuit with pulses of electrical energy; a frame member having a portion adapted to be immersed in the fluid when the assembly is in use, the frame member supporting said ultraviolet lamp and said ballast module; and an electrical system for receiving electrical energy, which has a voltage and a current, and providing such to said ballast module; wherein the resonance frequency is set in excess of 50 kHz.

According to another aspect of the present invention, there is provided a method of photochemically treating a fluid using a fluid treatment assembly, comprising immersing an ultraviolet lamp in the fluid when the assembly is in use; powering said ultraviolet lamp using a ballast module, said ballast module having a ballast electrically connected to said ultraviolet lamp for powering said ultraviolet lamp, the ballast having a resonant circuit with a resonance frequency for generating an alternating voltage source to power said ultraviolet lamp and a driver circuit with a pulse frequency for supplying the resonant circuit with pulses of electrical energy; supporting said ultraviolet lamp and said ballast module in a frame member having a portion adapted to be immersed in the fluid when the assembly is in use; and receiving electrical energy, which has a voltage and a current, and providing such to said ballast module; wherein the resonance frequency is set in excess of 50 kHz.

### BRIEF DESCRIPTION OF THE DRAWINGS

The present invention is illustrated by the embodiments shown in the drawings, in which:

FIG. 1 is a partial side view of a single modular UV lamp rack assembly in accordance with the invention.

FIG. 2 is a cross-sectional view of a ballast module and associated connections in accordance with the invention.

FIG. 3 is an end view of a ballast module used in FIG. 2.

FIG. 4 is a perspective view of a portion of a vertical conduit in a UV lamp rack assembly, useful in the present invention.

FIG. 5 is a system architecture diagram of a UV water treatment site in accordance with the invention.

FIG. 6 is a system architecture diagram of a ballast module in accordance with the invention.

FIG. 7 is a schematic diagram of a ballast in accordance a preferred embodiment of the invention.

FIG. 8 is a detailed schematic diagram of the best mode implementation of the preferred embodiment of FIG. 7 for the resonant circuit and lamp power control of the ballast.

FIG. 9 is a partial side view of an alternate UV lamp rack assembly in accordance with the invention.

### DETAILED DESCRIPTION OF PREFERRED EMBODIMENTS

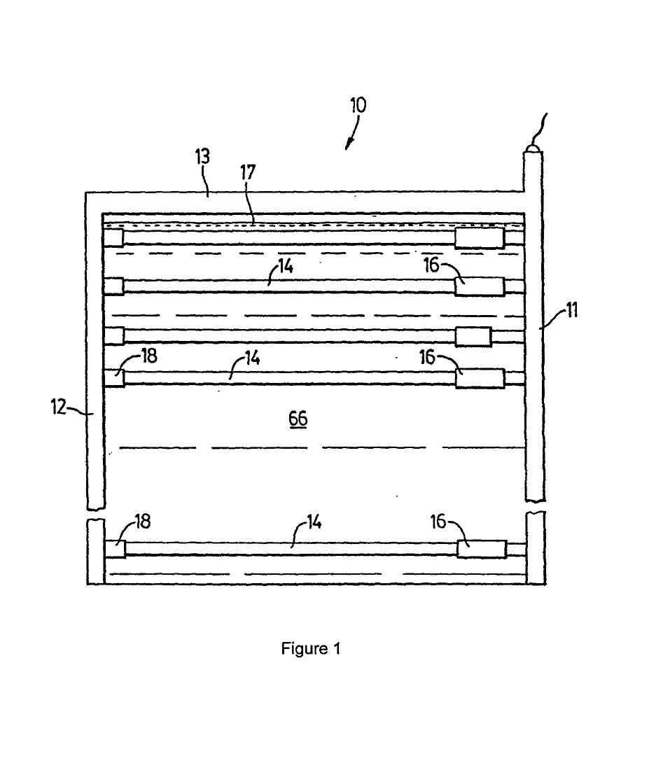

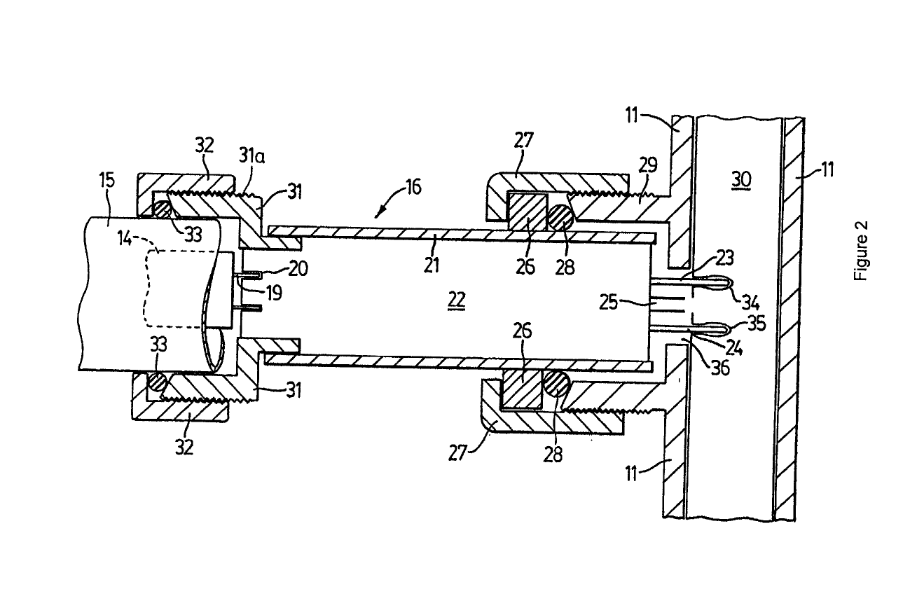

Referring to FIG. 1, there is an ultraviolet lamp rack 10 which has a vertical conduit 11, a vertical support member 12 and a bar 13. Located between vertical conduit 11 and vertical member 12 are a plurality of ultraviolet lamps 14 encased in transparent sleeves 15 (partially seen in FIG. 2), with associated ballast modules 16 and caps 18. The sleeves 15 are made from a material that permits passage of ultraviolet light. A preferred material is quartz glass. The ultraviolet lamps 14 and ballast modules 16 are submerged in liquid 66, e.g waste water. The surface of the liquid is shown at 17 and in FIG. 1 is beneath bar 13.

FIG. 2 shows the arrangement of one of the ballast modules 16. The ballast module 16 has internal components 22 encased in sleeve 21. At one end of ballast module 16 there are female electrical connectors 20 for cooperation with electrical pins 19 on ultraviolet lamp 14. At the other end of ballast module 16 there is an electrical line pin 23 and an electrical neutral pin 24. Between line pin 23 and neutral pin 24 there is an electrical insulation barrier 25. Attached to sleeve 21 is a retaining ring 26, the purpose of which will be explained hereinafter.

FIG. 2 also shows vertical conduit 11 in which there are female electrical connectors 34 and 35, which are electrically connected to electrical conduits 30, e.g. wires, strips, laminates. There is an aperture 36 adjacent to connectors 34 and 35, through which pins 23 and 24 may be connected to connectors 34 and 35 respectively. Attached, e.g. welded, to vertical conduit 11 is a tubular stub 29, which has an exterior screw thread, as shown in FIG. 2 and FIG. 4. Ballast module 16 is held in place by means of an internally screw threaded coupling 27. The joint between ballast module 16 and tubular stub 29 is made watertight by means of an O-ring 28, which is trapped between retaining ring 26 and tubular stub 29.

As indicated above, the ultraviolet light lamp 14 is electrically connected to ballast module 16 by means of pins 19 and female connectors 20. At the end of ballast module 16 adjacent to the connectors 20, there is a tubular stub 31 that has an external screw thread 31a. Tubular stub 31 is connected to sleeve 21 by a weld or similar. It will be understood that tubular stub 31 may be an integral part of sleeve 21. Quartz sleeve 15 surrounds ultraviolet lamp 14. The connection between the quartz sleeve 15 and tubular stub 31, and thus between ultraviolet lamp 14 and ballast module 16, is kept waterproof by means of an O-ring 33 which is trapped between tubular stub 31 and internally threaded retaining nut 32.

It will be understood that other arrangements for securing the ballast module and lamps in place are possible without departing from the essence of the invention. For example, sleeve 16 and tubular stub 29 may have the same diameter, and abutting ends may be externally threaded and held together with an internally threaded coupling which screws onto both the sleeve and the stub.

It will be understood that, although the diameter of the sleeves 21 of the ballast modules 16 are substantially the same as the sleeves 15 of the ultraviolet lamps to minimalize headloss of water flow, the diameter of between these sleeves (21, 15) may differ while maintaining a minimal of headloss.

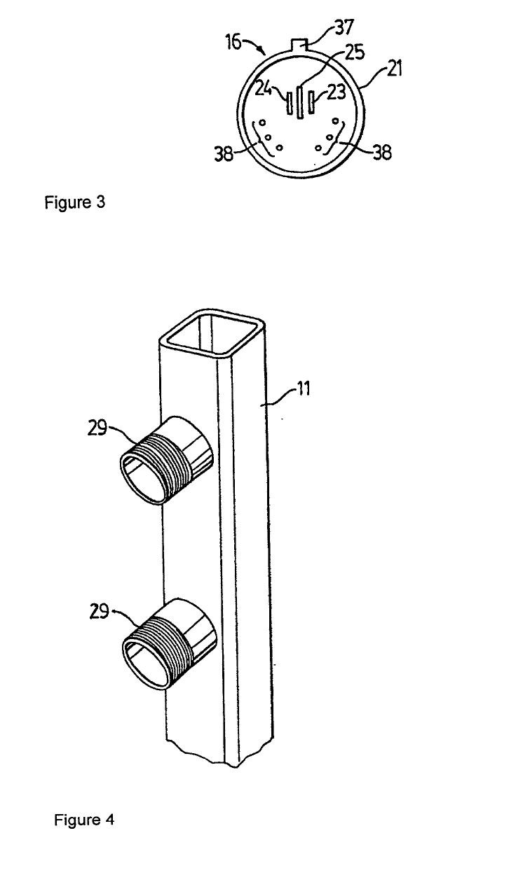

FIG. 3 shows an end of ballast module 16, which has line and neutral pins 23 and 24 separated by an electrical insulation barrier 25. The ballast module end may have auxiliary pins 38 for alarms and other communications features or instead all communications may be passed along pins 23 and 24.

It will be understood that electrical pins 23 and 24 form an electrical connection with electrical conduits 30 when pushed into female electrical connectors 34 and 35 respectively.

Although the drawings show electrical power being fed to ballast modules 16 by means of wires, strips or laminates 30 through conduit 11, electrical power may be fed to ballast module 16 through means external to conduit 11. In such an instance, waterproof wires may be used, which enter a waterproof coupling to the ballast module. As will be understood, in such an instance, conduit 11 could be replaced by a submersible tube or bar which merely supports ballast module 16. Such support may be provided by a flexible or rigid boot attached to the submersible bar.

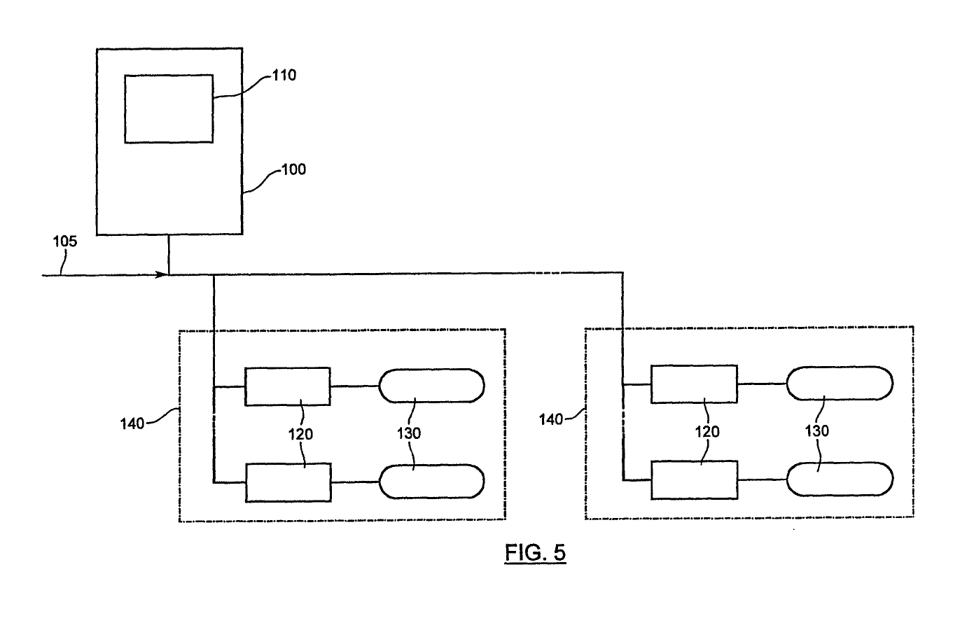

Referring to FIG. 5, there is provided a system architecture diagram of an UV water treatment site. The site has an assembly control unit 100 with an operator interface 110. Electrical energy is carried on power lines 105 to modular UV lamp rack assemblies 140 and to ballast modules 120 for supply to UV lamps 130. Operator interface 110 provides the necessary monitoring and control information to the operator, and the controls for the operator to operate the UV lamp rack assemblies.

Communications between assembly control unit 100 and modular UV lamp rack assemblies 140 and ballast modules 120 are carried over power lines 105. Power line transceivers manufactured by Intellon Corporation may be used. Alternatively, communications may be carried over separate lines such as a twisted-pair cable utilizing RS485 communication protocol or similar.

Typically, assembly control unit 100 is a computer dedicated with appropriate input and output interfaces. Various flow or dose control algorithms and programs can be stored and executed from assembly control unit 100. Assembly control unit 100 may also have intermediate control units between the operator station and the ballast modules. Without departing from the scope of this invention, it will be understood by those skilled in the art that the ballast modules may be designed with more or less processing power and may further be programmable.

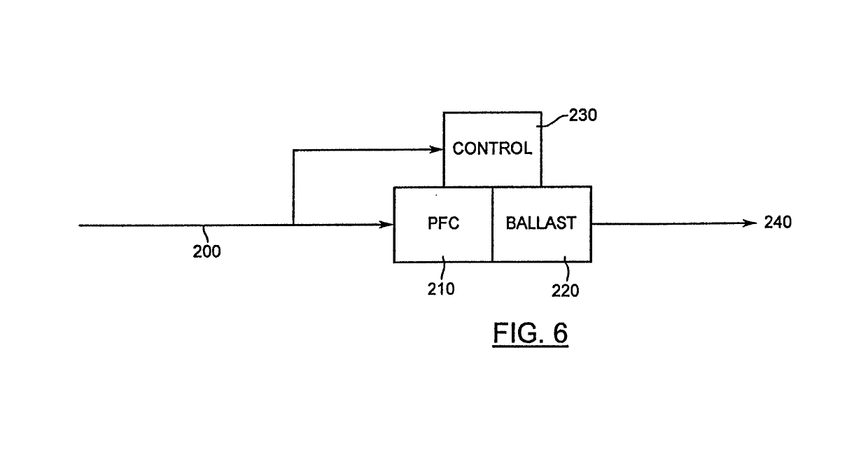

Referring to FIG. 6, there is illustrated a block diagram of a ballast module 120. Electrical energy is supplied to ballast module 120 via power line 200. Ballast module 120 is composed of three main sections: power factor section 210, ballast 220, and control section 230. Output 240 of electrical energy is applied to a UV lamp.

The power factor section 210 electrically couples the power line 200 to the ballast 220 and substantially synchronizes the voltage and current of the electrical energy being used by the ultraviolet lamp as viewed by an electrical energy monitor. The power factor circuits are generally well known in the art and a number of different circuits may be used in ballast module 120. Synchronization of voltage and current is either required by some utilities or required for cheaper electricity rates. While power factoring can be performed at a central location, beyond certain power usage levels, separate facilities for electromagnetic emission suppression and cooling may also be required. It is thus advantageous to place the power factoring function within the ballast module as electromagnetic emission suppression and cooling for the ballast are also available for the power factor circuits.

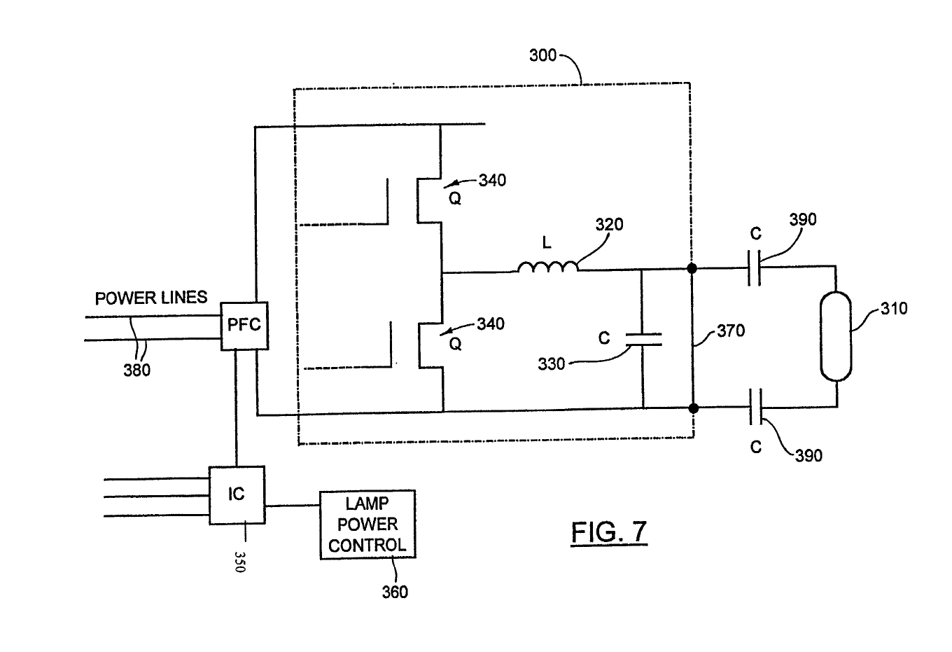

Referring to the preferred embodiment of FIG. 7, there is illustrated a schematic of an electronic ballast 300 for generating the alternating voltage required for an ultraviolet lamp 310. The electronic ballast 300 is composed of a series resonant circuit having an inductor 320 and a capacitor 330 with a resonance frequency of about 135 kHz. The resonant circuit is driven by a driver circuit having two power transistors 340 under the control of integrated circuit (IC) 350. The frequency of the pulses of electrical energy (pulse frequency) provided by the driver circuit to the resonant circuit is determined by lamp power control 360. The pulse frequency is set to vary from 150 to 200 kHz. The closer the pulse frequency is to the resonance frequency, the greater the power transfer to the resonant circuit and therefore the ultraviolet lamp 310. In the preferred embodiment, the maximum power transfer of 100% of lamp power is set to occur at a pulse frequency of 150 kHz, and the minimum power transfer of 50% of lamp power is set to occur at 200 kHz. Alternately, it will be understood by those skilled in the art that other power settings, and pulse and resonance frequency combinations may be used as desired.

Referring to FIG. 7, power outlets 370 to UV lamp 310 are isolated from power lines 380 by capacitors 390. The operation of ballast 300 at these high frequencies permits the use of capacitors, instead of relatively large transformers, to provide an additional safety measure.

Referring to FIG. 6, control section 230 permits the assembly control unit to control the pulse frequency of the ballast and thereby the power level of the UV lamp between 100% and 50%, and to shut down the UV lamp as desired. Control section 230 further monitors the operating temperature of the ballast module at the hot spots e.g. power transistors 340 in FIG. 7. Beyond a certain set temperature, the control section shuts down the ballast and signals the assembly control unit that there has been an over-temperature shut down. Without departing from the scope of this invention, it will be understood by those skilled in the art that the control section may have more sensors and monitoring functions.

The circuits of a ballast module, as shown in FIG. 6, are laid out on a print circuit board encased in a thermal conductive compound within the sleeve of the ballast module. The thermal conductive compound is in contact with the sleeve for an improved thermal path to conduct away the heat.

The IC 350 may be an IC manufactured by Microlinear designated as ML4826. Other chips with the same functionality may also be used.

It will be understood by those skilled in the art that the resonance frequency and the range of the pulse frequency may be set higher or lower and that the range of the pulse frequency can be below the resonance frequency instead of above.

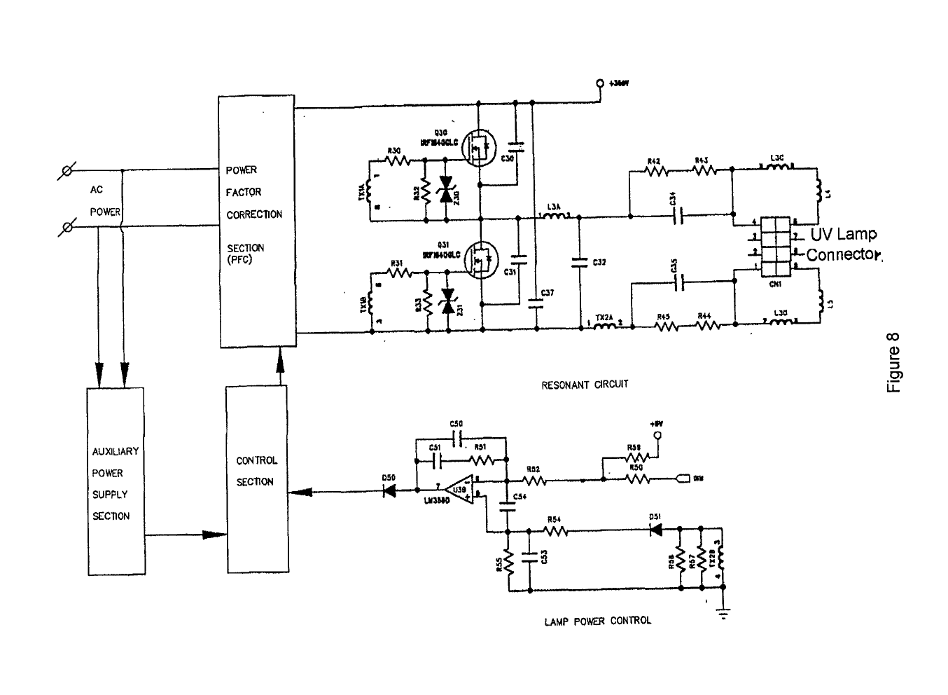

Referring to FIG. 8, there is provided a detailed schematic diagram of the best mode implementation of the preferred embodiment of FIG. 7 for the resonant circuit and lamp power control of a ballast. The best mode implementation for a ballast module further includes (not shown) circuits for lamp failure detection, current control, voltage control, and communications by a twisted-pair cable.

The present invention is useful for the treatment of a wide range of fluids, e.g. gases and liquids. It is preferable that the fluid is flowing around the radiation source and the excitation controlling means. For example, a rack with attached ballast modules and ultraviolet lamps is immersed in a flowing gas so that a stream of gas flows over the ultraviolet lamps.

The present invention is particularly useful for the treatment of water, e.g. for wastewater disinfection, drinking water disinfection, advanced oxidation treatment and other water treatment processes. The rack with attached ballast modules and ultraviolet lamps preferably is immersed in the water so that a stream of water flows over the ultraviolet lamps. Electrical power is fed to the lamps via the ballast modules, preferably by means of wires or laminates of the present invention through a tubular member of the rack.

One of the advantages of this aspect of the present invention is that the water that is being treated can be used to cool the ballast modules. This removes the necessity for external forced air cooling or for air conditioning equipment. Furthermore, the ballast modules can easily be serviced in situ, removed from service or replaced in the same way that ultraviolet lamps may be serviced or replaced. Any downtime for operation is thus kept to a minimum.

One of the advantages of this aspect of the present invention is that the power levels to the ultraviolet lamps may be individually set. The radiation output from UV lamps decreases with age. A relatively new UV lamp in an assembly may be set at a lower power level than the relatively old UV lamps in the assembly while maintaining the same radiation output level.

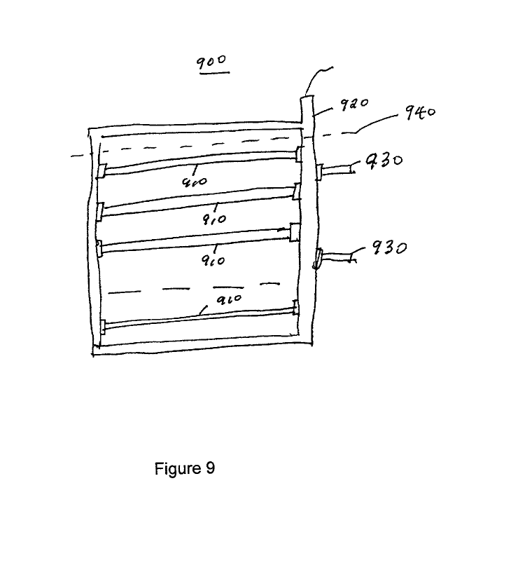

Referring to FIG. 9, there is shown a partial side view of an alternate UV lamp rack assembly 900 in accordance with the invention. The alternate UV lamp rack 900, partially immersed in a fluid 940 when in use, comprises UV lamps 910 and ballast modules 930 supported in an elongate frame member 920. Each of the ballast modules 930 is electrically connected to at least one UV lamp 910. Preferably, each of the ballast modules 930 is connected in proximity to only one UV lamp 910. It will be understand that the ballast modules 930 may be arranged in various configurations with the member 920 and the UV lamps 910.

It will be understood that the present invention is applicable to low pressure standard output lamps, low pressure high output lamps, low pressure amalgam lamps, medium pressure lamps, electrodeless lamps and excimer lamps.

It will be understood that the present invention may be applied to treatment of fluids other than just water or wastewater.

It will be understood that the ballast in the present invention may be operated over extremely wide frequency settings for the resonance and pulse frequencies. It is anticipated that the resonance frequency and pulse frequency range may be set over at least 50 kHz to 1 MHz.

Although preferred embodiments of the invention have been described herein, it will be understood by those skilled in the art that variations may be made thereto without departing from the scope of the invention or the appended claims.

1. A fluid treatment assembly, comprising:
a plurality of ultraviolet lamps adapted to be immersed in a fluid when the assembly is in use;
a plurality of ballast modules for powering said ultraviolet lamps, each of said ballast modules having a ballast electrically connected to at least one ultraviolet lamp for powering said at least one ultraviolet lamp, the ballast having a resonant circuit with a resonance frequency for generating an alternating voltage source to power said at least one ultraviolet lamp and a driver circuit with a pulse frequency for supplying the resonant circuit with pulses of electrical energy;
a frame member having a portion adapted to be immersed in the fluid when the assembly is in use, the frame member supporting said ultraviolet lamps and said ballast modules; and
an electrical system for receiving electrical energy, which has a voltage and a current, and providing such to said ballast modules;
wherein the resonance frequency is set in excess of 50 kHz.

2. The fluid treatment assembly of claim 1, wherein the resonance frequency is substantially set in a first range of 50 kHz to 1 MHz.

3. The fluid treatment assembly of claim 1, wherein the resonance frequency is substantially set in a first range of 100 kHz to 150 kHz.

4. The fluid treatment assembly of claim 1, wherein the resonance frequency is substantially set in a first range of 200 kHz to 250 kHz.

5. The fluid treatment assembly of claim 2, wherein the power supplied to said at least one ultraviolet lamp decreases the further the pulse frequency deviates from the resonance frequency and wherein the pulse frequency is varied substantially within a second range of 50 kHz to 1 MHz to control the power supplied to said at least one ultraviolet lamp.

6. The fluid treatment assembly of claim 3, wherein the power supplied to said at least one ultraviolet lamp decreases the further the pulse frequency deviates from the resonance frequency and wherein the pulse frequency is varied substantially within a second range of 150 kHz to 200 kHz to control the power supplied to said at least one ultraviolet lamp.

7. The fluid treatment assembly of claim 4, wherein the power supplied to said at least one ultraviolet lamp decreases the further the pulse frequency deviates from the resonance frequency and wherein the pulse frequency is varied substantially within a second range of 150 kHz to 200 kHz to control the power supplied to said at least one ultraviolet lamp.

8. The fluid treatment assembly of claim 1, wherein the resonant circuit comprises of a capacitance and an inductance in series.

9. The fluid treatment assembly of claim 1, further comprising an assembly control unit for controlling said ultraviolet lamps; wherein each of said ballast modules further comprises a control section for controlling the ballast and interfacing with said assembly control unit.

10. The fluid treatment assembly of claim 9, wherein the control section further comprises a monitor section for monitoring its respective ballast module and said at least one ultraviolet lamp, and reporting to said assembly control unit.

11. The fluid treatment assembly of claim 1, wherein said ballast modules are removable from the fluid treatment assembly.

12. The fluid treatment assembly of claim 1, wherein each of said ballast modules further comprises a power factor section to substantially synchronize the voltage and current of the electrical energy as viewed by an electrical energy monitor.

13. The fluid treatment assembly of claim 1, wherein the resonance frequency is set at greater than 50 kHz for reduced size of components so that the width of a ballast sleeve of a ballast module is substantially the same as the width of a lamp sleeve of an ultraviolet lamp.

14. The fluid treatment assembly of claim 1, wherein said ballast modules are immersed in the fluid for cooling by the fluid.

15. A ballast for powering at least one ultraviolet lamp with electrical energy, said at least one ultraviolet lamp being for use in a photochemical treatment of a fluid, where the ballast is to be immersed in the fluid for cooling by the fluid, the ballast comprising:
a resonant circuit having a resonance frequency for generating an alternating voltage source to power said at least one ultraviolet lamp; and
a driver circuit having a pulse frequency for supplying the resonant circuit with pulses of electrical energy;
wherein the resonance frequency is set in excess of 50 kHz.

16. The ballast of claim 15, wherein the resonance frequency is substantially set in a first range of 50 kHz to 1 MHz.

17. The ballast of claim 15, wherein the resonance frequency is substantially set in a first range of 100 kHz to 150 kHz.

18. The ballast of claim 15, wherein the resonance frequency is substantially set in a first range of 200 kHz to 250 kHz.

19. The ballast of claim 16, wherein the power supplied to said at least one ultraviolet lamp decreases the further the pulse frequency deviates from the resonance frequency and wherein the pulse frequency is varied substantially within a second range of 50 kHz to 1 MHz to control the power supplied to said at least one ultraviolet lamp.

20. The ballast of claim 17, wherein the power supplied to said at least one ultraviolet lamp decreases the further the pulse frequency deviates from the resonance frequency and wherein the pulse frequency is varied substantially within a second range of 150 kHz to 200 kHz to control the power supplied to said at least one ultraviolet lamp.

21. The ballast of claim 18, wherein the power supplied to said at least one ultraviolet lamp decreases the further the pulse frequency deviates from the resonance frequency and wherein the pulse frequency is varied substantially within a second range of 150 kHz to 200 kHz to control the power supplied to said at least one ultraviolet lamp.

22. The ballast of claim 15, wherein the resonant circuit comprises a capacitance and an inductance in series.

23. The ballast of claim 15, wherein the resonance frequency is set at greater than 50 kHz for reduced size of components so that the width of a ballast sleeve of the ballast is substantially the same as the width of a lamp sleeve of an ultraviolet lamp.

24. A ballast module for use in a fluid treatment assembly having a frame to support at least one ultraviolet lamp under the control of an assembly control unit, the ballast module comprising:
a ballast for converting electrical energy to a form suitable to power at least one ultraviolet lamp; and
a control section for interfacing with the assembly control unit and controlling said ballast under direction of the assembly control unit.

25. The ballast module of claim 24, wherein the ballast comprises:
a resonant circuit having a resonance frequency for generating an alternating voltage source to power said at least one ultraviolet lamp;
a driver circuit having a pulse frequency for supplying the resonant circuit with pulses of electrical energy;
wherein the resonance frequency is set in excess of 50 kHz.

26. The ballast module of claim 25, wherein the resonance frequency is substantially set in a first range of 50 kHz to 1 MHz.

27. The ballast module of claim 25, wherein the resonance frequency is substantially set in a first range of 100 kHz to 150 kHz.

28. The ballast module of claim 25, wherein the resonance frequency is substantially set in a first range of 200 kHz to 250 kHz.

29. The ballast module of claim 26, wherein the power supplied to said at least one ultraviolet lamp decreases the further the pulse frequency deviates from the resonance frequency and wherein the pulse frequency is varied substantially within a second range of 50 kHz to 1 MHz to control the power supplied to said at least one ultraviolet lamp.

30. The ballast module of claim 27, wherein the power supplied to said at least one ultraviolet lamp decreases the further the pulse frequency deviates from the resonance frequency and wherein the pulse frequency is varied substantially within a second range of 150 kHz to 200 kHz to control the power supplied to said at least one ultraviolet lamp.

31. The ballast module of claim 28, wherein the power supplied to said at least one ultraviolet lamp decreases the further the pulse frequency deviates from the resonance frequency and wherein the pulse frequency is varied substantially within a second range of 150 kHz to 200 kHz to control the power supplied to said at least one ultraviolet lamp.

32. The ballast module of claim 24, further comprising a power factor section to substantially synchronize the voltage and current of the electrical energy as viewed by an electrical energy monitor.

33. The ballast module of claim 24, further comprising a monitor section for monitoring the ballast module and said at least one ultraviolet lamp, and reporting to said assembly control unit.

34. The ballast module of claim 25, wherein the resonance frequency is set at greater than 50 kHz for reduced size of components so that the width of a ballast sleeve is substantially the same as the width of a lamp sleeve of said at least one ultraviolet lamp.

35. A method of photochemically treating a fluid using a fluid treatment assembly, comprising
immersing a plurality of ultraviolet lamps in the fluid when the assembly is in use;
powering said ultraviolet lamps using a plurality of ballast modules, each of said ballast modules having a ballast electrically connected to at least one ultraviolet lamp for powering said at least one ultraviolet lamp, the ballast having a resonant circuit with a resonance frequency for generating an alternating voltage source to power said at least one ultraviolet lamp and a driver circuit with a pulse frequency for supplying the resonant circuit with pulses of electrical energy;
supporting said ultraviolet lamps and said ballast modules in a frame member having a portion adapted to be immersed in the fluid when the assembly is in use; and
receiving electrical energy, which has a voltage and a current, and providing such to said ballast modules;
wherein the resonance frequency is set in excess of 50 kHz.

36. The method of claim 35, wherein the resonance frequency is substantially set in a first range of 50 kHz to 1 MHz.

37. The method of claim 35, wherein the resonance frequency is substantially set in a first range of 100 kHz to 150 kHz.

38. The method of claim 35, wherein the resonance frequency is substantially set in a first range of 200 kHz to 250 kHz.

39. The method of claim 36, wherein the power supplied to said at least one ultraviolet lamp decreases the further the pulse frequency deviates from the resonance frequency and wherein the pulse frequency is varied substantially within a second range of 50 kHz to 1 MHz to control the power supplied to said at least one ultraviolet lamp.

40. The method of claim 37, wherein the power supplied to said at least one ultraviolet lamp decreases the further the pulse frequency deviates from the resonance frequency and wherein the pulse frequency is varied substantially in a second range of 150 KHz to 200 kHz to control the power supplied to said at least one ultraviolet lamp.

41. The method of claim 38, wherein the power supplied to said at least one ultraviolet lamp decreases the further the pulse frequency deviates from the resonance frequency and wherein the pulse frequency is varied substantially in a second range of 150 KHz to 200 kHz to control the power supplied to said at least one ultraviolet lamp.

42. The method of claim 35, wherein the resonant circuit comprises of a capacitance and an inductance in series.

43. The method of claim 35, further comprising
monitoring said ballast modules and said ultraviolet lamps.

44. The method of claim 35, wherein said ballast modules are removable from the fluid treatment assembly.

45. The method of claim 35, further comprising
synchronizing the voltage and current of the electrical energy as viewed by an electrical energy monitor.

46. The method of claim 35, wherein the resonance frequency is set at greater than 50 kHz for reduced size of components so that the width of a ballast sleeve of a ballast module is substantially the same as the width of a lamp sleeve of an ultraviolet lamp.

47. The method of claim 35, further comprising
immersing said ballast modules in the fluid for cooling by the fluid.

48. A method of operating a ballast for powering at least one ultraviolet lamp with electrical energy, said at least one ultraviolet lamp being for use in a photochemical treatment of a fluid, where the ballast is to be immersed in the fluid for cooling by the fluid, the method comprising:
generating an alternating voltage source to power said at least one ultraviolet lamp using a resonant circuit having a resonance frequency; and
supplying the resonant circuit with pulses of electrical energy using a driver circuit having a pulse frequency;
wherein the resonance frequency is set in excess of 50 kHz.

49. The method of claim 48, wherein the resonance frequency is substantially set in a first range of 50 kHz to 1 MHz.

50. The method of claim 48, wherein the resonance frequency is substantially set in a first range of 100 kHz to 150 kHz.

51. The method of claim 48, wherein the resonance frequency is substantially set in a first range of 200 kHz to 250 kHz.

52. The method of claim 49, wherein the power supplied to said at least one ultraviolet lamp decreases the further the pulse frequency deviates from the resonance frequency and wherein the pulse frequency is varied substantially within a second range of 50 kHz to 1 MHz to control the power supplied to said at least one ultraviolet lamp.

53. The method of claim 50, wherein the power supplied to said at least one ultraviolet lamp decreases the further the pulse frequency deviates from the resonance frequency and wherein the pulse frequency is varied substantially within a second range of 150 kHz to 200 kHz to control the power supplied to said at least one ultraviolet lamp.

54. The method of claim 51, wherein the power supplied to said at least one ultraviolet lamp decreases the further the pulse frequency deviates from the resonance frequency and wherein the pulse frequency is varied substantially within a second range of 150 kHz to 200 kHz to control the power supplied to said at least one ultraviolet lamp.

55. The method of claim 48, wherein the resonant circuit comprises of a capacitance and an inductance in series.

56. The method of claim 48, wherein the resonance frequency is set at greater than 50 kHz for reduced size of components so that the width of a ballast sleeve of the ballast is substantially the same as the width of a lamp sleeve of an ultraviolet lamp.

57. A fluid treatment assembly, comprising:
a ultraviolet lamp adapted to be immersed in a fluid when the assembly is in use;
a ballast module for powering said ultraviolet lamp, said ballast module having a ballast electrically connected to said ultraviolet lamp for powering said ultraviolet lamp, the ballast having a resonant circuit with a resonance frequency for generating an alternating voltage source to power said ultraviolet lamp and a driver circuit with a pulse frequency for supplying the resonant circuit with pulses of electrical energy;
a frame member having a portion adapted to be immersed in the fluid when the assembly is in use, the frame member supporting said ultraviolet lamp and said ballast module; and
an electrical system for receiving electrical energy, which has a voltage and a current, and providing such to said ballast module;
wherein the resonance frequency is set in excess of 50 kHz.

58. The fluid treatment assembly of claim 57, wherein the resonance frequency is substantially set in a first range of 50 kHz to 1 MHz.

59. The fluid treatment assembly of claim 57, wherein the resonance frequency is substantially set in a first range of 100 kHz to 150 kHz.

60. The fluid treatment assembly of claim 57, wherein the resonance frequency is substantially set in a first range of 200 kHz to 250 kHz.

61. The fluid treatment assembly of claim 58, wherein the power supplied to said ultraviolet lamp decreases the further the pulse frequency deviates from the resonance frequency and wherein the pulse frequency is varied substantially within a second range of 50 kHz to 1 MHz to control the power supplied to said ultraviolet lamp.

62. The fluid treatment assembly of claim 59, wherein the power supplied to said ultraviolet lamp decreases the further the pulse frequency deviates from the resonance frequency and wherein the pulse frequency is varied substantially within a second range of 150 kHz to 200 kHz to control the power supplied to said ultraviolet lamp.

63. The fluid treatment assembly of claim 60, wherein the power supplied to said ultraviolet lamp decreases the further the pulse frequency deviates from the resonance frequency and wherein the pulse frequency is varied substantially within a second range of 150 kHz to 200 kHz to control the power supplied to said ultraviolet lamp.

64. The fluid treatment assembly of claim 57, wherein the resonant circuit comprises of a capacitance and an inductance in series.

65. The fluid treatment assembly of claim 57, further comprising an assembly control unit for controlling said ultraviolet lamp; wherein said ballast module further comprises a control section for controlling the ballast and interfacing with said assembly control unit.

66. The fluid treatment assembly of claim 65, wherein the control section further comprises a monitor section for monitoring said ballast module and said ultraviolet lamp, and reporting to said assembly control unit.

67. The fluid treatment assembly of claim 57, wherein said ballast module is removable from the fluid treatment assembly.

68. The fluid treatment assembly of claim 57, wherein said ballast module further comprises a power factor section to substantially synchronize the voltage and current of the electrical energy as viewed by an electrical energy monitor.

69. The fluid treatment assembly of claim 57, wherein the resonance frequency is set at greater than 50 kHz for reduced size of components so that the width of a ballast sleeve of a ballast module is substantially the same as the width of a lamp sleeve of said ultraviolet lamp.

70. The fluid treatment assembly of claim 57, wherein said ballast module is immersed in the fluid for cooling by the fluid.

71. A method of photochemically treating a fluid using a fluid treatment assembly, comprising
immersing an ultraviolet lamp in the fluid when the assembly is in use;
powering said ultraviolet lamp using a ballast module, said ballast module having a ballast electrically connected to said ultraviolet lamp for powering said ultraviolet lamp, the ballast having a resonant circuit with a resonance frequency for generating an alternating voltage source to power said ultraviolet lamp and a driver circuit with a pulse frequency for supplying the resonant circuit with pulses of electrical energy;
supporting said ultraviolet lamp and said ballast module in a frame member having a portion adapted to be immersed in the fluid when the assembly is in use; and
receiving electrical energy, which has a voltage and a current, and providing such to said ballast module;
wherein the resonance frequency is set in excess of 50 kHz.

72. The method of claim 71, wherein the resonance frequency is substantially set in a first range of 50 kHz to 1 MHz.

73. The method of claim 71, wherein the resonance frequency is substantially set in a first range of 100 kHz to 150 kHz.

74. The method of claim 71, wherein the resonance frequency is substantially set in a first range of 200 kHz to 250 kHz.

75. The method of claim 72, wherein the power supplied to said ultraviolet lamp decreases the further the pulse frequency deviates from the resonance frequency and wherein the pulse frequency is varied substantially within a second range of 50 kHz to 1 MHz to control the power supplied to said ultraviolet lamp.

76. The method of claim 73, wherein the power supplied to said ultraviolet lamp decreases the further the pulse frequency deviates from the resonance frequency and wherein the pulse frequency is varied substantially in a second range of 150 kHz to 200 kHz to control the power supplied to said at least one ultraviolet lamp.

77. The method of claim 74, wherein the power supplied to said ultraviolet lamp decreases the further the pulse frequency deviates from the resonance frequency and wherein the pulse frequency is varied substantially in a second range of 150 kHz to 200 kHz to control the power supplied to said at least one ultraviolet lamp.

78. The method of claim 71, wherein the resonant circuit comprises of a capacitance and an inductance in series.

79. The method of claim 71, further comprising
monitoring said ballast module and said ultraviolet lamp.

80. The method of claim 71, wherein said ballast module is removable from the fluid treatment assembly.

81. The method of claim 71, further comprising
synchronizing the voltage and current of the electrical energy as viewed by an electrical energy monitor.

82. The method of claim 71, wherein the resonance frequency is set at greater than 50 kHz for reduced size of components so that the width of a ballast sleeve of said ballast module is substantially the same as the width of a lamp sleeve of said ultraviolet lamp.

83. The method of claim 71, further comprising
immersing said ballast module in the fluid for cooling by the fluid.
